(19) United States
(12) Patent Application Publication
(10) Pub. No.: US 2012/0197685 A1
(43) Pub. Date: Aug. 2, 2012

(54) GEOGRAPHICAL INFORMATION SYSTEM AND METHOD FOR ACCESSING AND DISPLAYING AFFORDABILITY DATA

(76) Inventors: Adam Mays, Chicago, IL (US); Peter Haas, Chicago, IL (US); Timothy Lang, Wheaton, IL (US); Paul Esling, Chicago, IL (US)

(21) Appl. No.: 13/358,202

(22) Filed: Jan. 25, 2012

Related U.S. Application Data
(60) Provisional application No. 61/436,157, filed on Jan. 25, 2011.

(51) Int. Cl. G06Q 30/02

(52) U.S. Cl. 705/7.34

(57) ABSTRACT

The present invention is a computer-implemented method and system for providing a graphical representation of a geographic area where household expenses, for example, transportation costs, fit a user's budgetary restrictions. The method and system allows for users to select a geographic region to search, select values for individualized household variables to determine household transportation costs, and select a affordability criteria threshold for the search results.

### CROSS REFERENCE TO RELATED APPLICATION

This application claims priority to provisional application Ser. No. 61/436,157 filed on Jan. 25, 2011 to the extent allowed by law, and which is incorporated herein by reference.

### THE FIELD OF THE INVENTION

The invention relates to systems and methods for processing data or information to create visual images and graphical displays that convey the data or information. Specifically, the present invention is a computer-implemented method and system for providing a graphical representation of a geographic area where household expenses, for example, transportation costs, fit a user's budgetary restrictions.

### BACKGROUND OF THE INVENTION

The cost of living for an American family consists of many components. The two larger components are cost of housing and cost of transportation. Housing affordability is most commonly understood as the extent to which a household's income can cover the purchase price of a home. However, the traditional definition of housing affordability may be too limited. The cost of transportation, while not currently factored into the housing affordability equation, has become increasingly central to family budgets, given their choices to live farther from jobs and as today's property development patterns require families to use their cars more often to run errands or take their children to school. Therefore, the affordability of housing should be considered in the context of the transportation costs associated with the neighborhood in which the home is located. The combination of housing and location provides a more valuable measure of affordability for a specific location.

Housing is considered affordable if it accounts for approximately 30% or less of a household's monthly budget. However, location costs, and more specifically, transportation costs, are often dramatically underestimated or ignored. Nationally, transportation is the second largest household expenditure after housing, ranging from less than 10% of the average household's expenditures in transit-rich areas to nearly 25% in many other areas. Based on calculations using the 2003 Consumer Expenditure Survey, the average U.S. household spends 19% of its budget on transportation.

Transportation costs also vary widely by neighborhood. Generally, housing is less expensive in areas that lack new investment or are farther from the central business district. However, household transportation costs increase in locations farther out from urban centers. Increasing gas prices have further increased the impact of transportation costs for households, businesses, employers, and, more recently, the home mortgage industry. Available data on the increased number of foreclosures and households unable to afford their homes and commutes show the need to more accurately predict and report the cost of transportation on a small geographic scale.

Previously, a household's transportation demand was considered to be primarily driven by household income and size. Larger and wealthier households tend to own more vehicles, select more expensive models, and drive more miles. However, transportation demand and the corresponding costs are highly dependent on the characteristics of the neighborhood. Neighborhood features such as availability and quality of transit service, access to amenities such as grocery stores, dry cleaners, day care, and movie theaters, and the number of accessible jobs shape how residents get around, where they go, and how much they ultimately spend on transportation. Neighborhoods with more of these features are considered “location efficient,” providing convenient access to shopping, services, and jobs, and low cost transportation alternatives to the automobile. However, the costs of these features, whether available or not, are not considered in the housing affordability standards used to allocate low-income housing tax credits or vouchers for other affordable housing programs. Nor are these costs considered for the most part, when lenders score individual home loan applications. Reframing nationally accepted affordability measures to combine both housing and transportation costs could allow low-income households to more easily qualify for home ownership, provide a substantial incentive to the private sector to invest in transit-oriented locations, and support the public sector in making investments that lower household transportation costs.

What is needed is a new method and system that allows individuals to customize data for their household so that individuals have more complete information on housing and transportation costs for geographic areas when selecting their housing locations and when making their travel choices.

What is also needed is a new method and system that allows users to view available real estate within a geographical area having costs that fit within a user's budgetary restrictions.

### SUMMARY OF THE INVENTION

The present invention provides computer-implemented methods and systems for providing a graphical representation of a geographic area where household expenses, for example, transportation costs, fit a user's budgetary restrictions.

The computer-implemented methods of the present invention display affordability data of areas in a selected geographic region. The affordability criteria is a defined threshold of combined household and transportation costs as a percentage of income in a specific geographic area. The computer-implemented methods, in some embodiments, comprise i) building a database of geographic variables for selected geographic areas, ii) building a table of transportation costs using geographic variables, household variables, and user inputted variables, iii) selecting a geographic region to search, selecting a value for each of the household variables, and selecting the affordability criteria threshold through a user interface; iv) providing information from a real estate database to identify available properties in the selected geographic region with costs that are above or below the affordability criteria threshold, and v) displaying the areas with average housing costs below the affordability criteria threshold as affordable and distinguished on the display from areas with average housing costs above the affordability criteria threshold and marked as unaffordable.

The systems of the present invention, in some embodiments, comprise i) a computer system which includes a processor, a memory component, a communication link such as an internet connection, and a display device; ii) a table of transportation costs calculated by using geographic variables, household variables, and user inputted variables, iii) a database of geographic variables; and iv) a user interface which allows a user to select a geographic region to search, select values for each of the household variables, and select the affordability criteria threshold for the present invention.

### BRIEF DESCRIPTION OF DRAWINGS AND FIGURES

FIG. 1 is flow chart of a geographical information system according to the present invention;

FIG. 2 is an architectural diagram for the geographical information system shown in FIG. 1;

FIG. 3 is a flow chart of the process for running the method for the geographical information system shown in FIG. 1;

FIG. 4 is an embodiment of a user web interface for the geographical information system of the present invention of FIG. 1;

FIGS. 5 and 6 are tables setting forth the sources of independent and dependent variables used in the method of the geographical information system of FIG. 1;

FIG. 7 is a geographical display of housing costs as a percentage of income in a sample geographic region after performing the calculations of the method for the present invention in FIG. 1;

FIG. 8 is a geographical display of the affordability criteria for both housing and transportation costs after performing the calculations of the method for the present invention;

FIG. 9 is a table of background information for one sample geographic region used in the method of the geographical information system for the present invention shown in FIG. 1;

FIG. 10 is a table of housing and transportation costs obtained by running the method of the geographical information system of FIG. 1 in one sample geographic region;

FIG. 11 is a comparison graph of the affordability of various neighborhoods in the sample geographic region obtained by running the method of the geographical information system of the present invention in FIG. 1;

FIG. 12 is a table of sample multiple regression correlation results used in the method of the geographical information system of FIG. 1;

FIG. 13 is a geographical display of the transportation costs for selected areas in the sample geographical region after running the method of the present invention in FIG. 1; and

FIG. 14 is a flow chart illustrating the variables used in the method of calculating the total transportation costs for a household in the present invention of FIG. 1.

### DETAILED DESCRIPTION OF THE INVENTION

The present invention provides computer-implemented methods and systems for providing a graphical representation of a geographic area where household expenses, for example, transportation costs, fit a user's budgetary restrictions. The present invention is a useful tool for those seeking an affordable place to live, as well as those investigating the affordability of their current location. The household expenses may be any that vary from place to place, including, but not limited to, transportation, energy, water, food, telecommunications, education, utilities, and insurance.

The computer-implemented methods of the present invention display affordability data of areas in a selected geographic region. Affordability criteria is a defined threshold of combined household and transportation costs as percentage of income in a specific geographic area. The computer-implemented methods may comprise i) building a database of geographic variables for selected geographic areas, ii) building a table of transportation costs by using geographic variables, household variables, and user inputted variables, iii) selecting a geographic region to search, selecting a value for each of the household variables, and selecting the affordability criteria threshold through a user interface; iv) providing information from a real estate database to identify available properties in the selected geographic region with costs that are above or below the affordability criteria threshold, and v) displaying the areas with average housing costs below the affordability criteria threshold as affordable and distinguished on the display from areas with average housing costs above the threshold affordability criteria and marked as unaffordable. The display may be in the form of a table or a geographical map for the user.

The systems of the present invention may comprise i) a computer system which includes a processor, a memory component, a communication link such as an internet connection, and a display device; ii) a table of transportation costs calculated by using geographic and household variables, iii) a database of geographic variables; and iv) a user interface which allows a user to select a geographic region to search, select values for each of the household variables, and select the affordability criteria threshold for the present invention.

In an embodiment of the invention, the user enters on a web-page, a selected geographic region for the analysis as well as household information relevant to the expense or expenses being manipulated in the method of the present invention. In the case of transportation, this may be, for example and without limitation, household income, household size, number of commuters in the household, place(s) of work, and number of cars. In this embodiment, the household characteristics are used as inputs to determine transportation costs, for example. The household characteristics are combined with characteristics of geographic locations, drawn from a database. In the case of transportation, the characteristics of geographic locations may include, for example and without limitation, density of development, average block size for blocks making up a given block group in a census tract, percentage of commuters in that areas that take public transit to work, average vehicle miles traveled (VMT) by household inhabitants, and the price of fuel. Using these household and geographic location-specific characteristics, the method will predict what the user's household expenses would be for every location in the selected region. The method then graphically displays a map of the region, with areas that have predicted household expenses below an affordability criteria threshold highlighted and made distinguishable on the map from those areas that are not affordable or have predicted household expenses below the affordability criteria threshold. Using housing costs from a real estate database, such as an MLS or Zillow for example, the method of the present invention identifies all properties in every area of the selected geographic region that are above or below the affordability criteria threshold by calculating the housing costs associated with that property and combining those specific housing costs with the transportation costs determined for the geographic area. The sum total of these housing and transportation costs are then divided by the household income to determine the affordability criteria. Using the web-interface, the user also has flexibility to change the affordability criteria threshold and the method of one or more embodiments will rerun the affordability cost analysis.

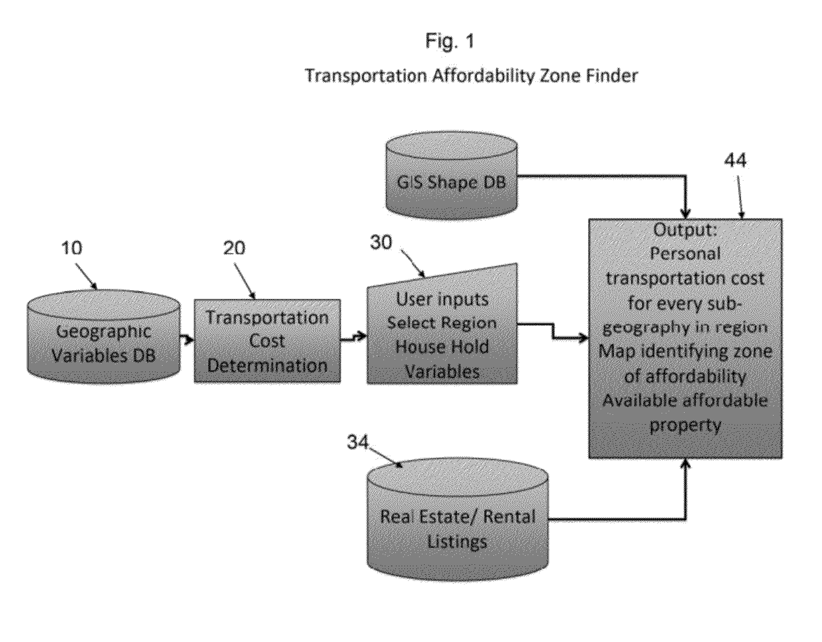

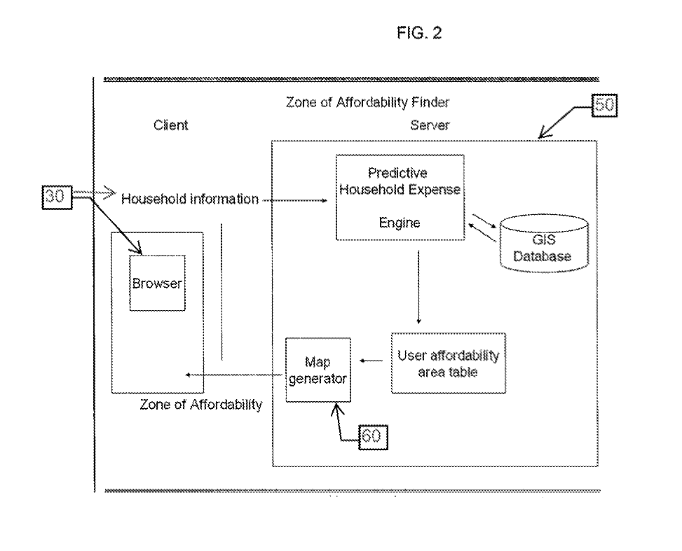

Referring to FIGS. 1 and 2, an embodiment of the present invention comprises at least a database of geographic variables 10, a determination of transportation costs 20, a user interface 30 that allows a user to select a geographic region for the search and enter household variables, an internet connection 40, a processor 50, and a map server 60. For ease of use and administration, in an embodiment, the user interface 30 is located remotely from the processor 50, the server 60, the geographic database 10, and the transportation cost determination 20. In an embodiment, the user interface 30 accesses a remote server 60, the processor 50, the geographic database 10 and the cost determination 20 via the Internet (i.e. via a web browser). Any suitable remote connection may be used, such as a basic Internet connection, a virtual private network, a wide area network, or another connection that can be configured for reasonably secure access of the geographic database 10 and the transportation cost determination 20.

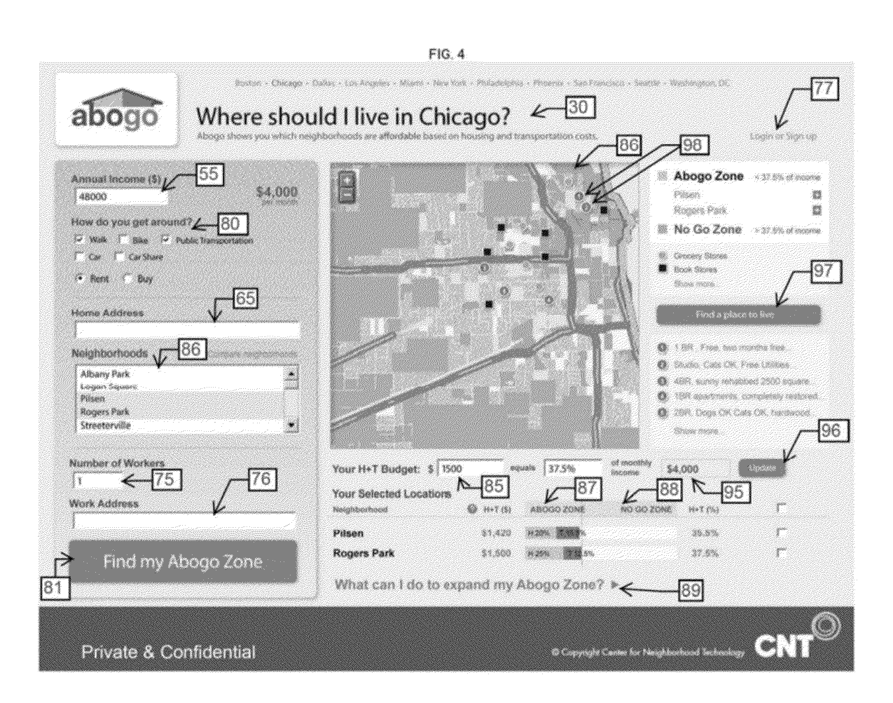

The preferred user interface 30 (FIG. 4) is a web-based application. In an embodiment, the user interface is written in PHP hypertext programming language. Typical components of a web-based application are: forms that allow the user to input information or select certain on-screen data, scripts or program code that interprets and/or processes the input information and generates and/or retrieves results, and templates in which the results may be placed before transmission to the browser by a web server. Any output from the system is rendered in a format understood by a web-browser, such as Microsoft Internet Explorer, Netscape Navigator, or Mozilla Firefox.

In an embodiment, a method of the present invention requires determination of actual transportation costs which take geographic and household factors into account. The transportation costs of the method are determined through a multi-dimensional, non-linear regression analysis. The independent variables in the method are household variables such as income, number of inhabitants, and geographic area.

The embodiment calculates the true affordability of a home based on its real estate market value or its rental market value, and the transportation costs incurred by its location It does so not only at the broad metropolitan area level, but also at the neighborhood level. Used at the community level the method of the present invention can help individual households assess which neighborhoods in a region are most affordable and can identify available affordable real estate or rental properties in that area and it can help policymakers determine where resources should be focused to enhance affordability.

Generally, the computer-implemented methods of the present invention calculate the sum of the average housing costs and the average transportation costs for a neighborhood (represented by a census block group for example) and divides by the average neighborhood income to develop a distribution of the effective cost of living for a particular geographic area.

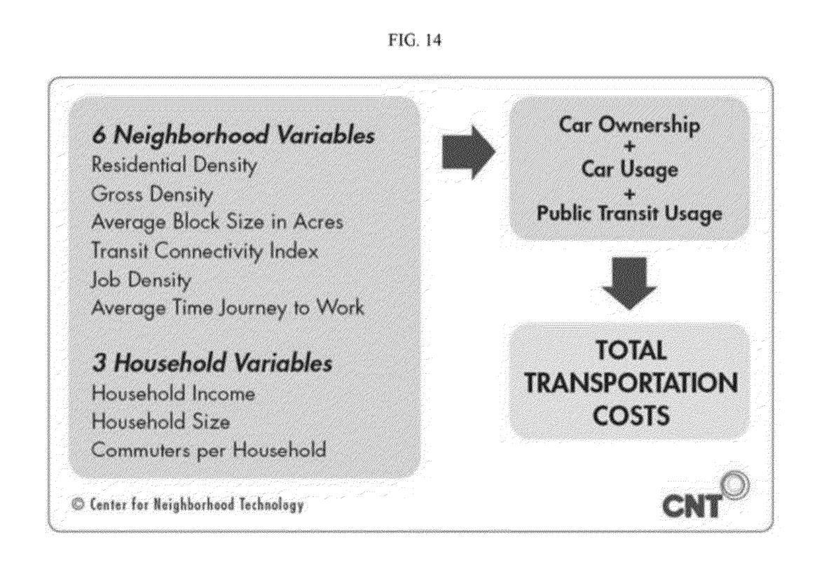

The computer-implemented methods of the present invention further include a three-part transportation cost determination developed specifically to predict a household's total transportation expenditures for a given household size and income at the neighborhood level for regions across the United States. The transportation cost determination of the present invention comprises three separate multiple regression equations. The transportation cost determination combines several built environment and socioeconomic variables, with various weights, to predict the three separate variables that sum to total transportation costs: i) automobile ownership, ii) automobile use in annual household miles, and iii) annual household transit use. In an embodiment, these three components are the dependent variables in the cost determination and are affected by a combination of six independent built environment variables (or neighborhood variables) and three independent household variables. (FIG. 14) Together, these nine independent variables represent the independent neighborhood and socioeconomic variables that predict household transportation costs at the census block group level, the smallest geography available to approximate neighborhood data profiles. It is important to determine these costs at a neighborhood level, given that the independent variables can vary block by block. Prices for automobile ownership, automobile use, and transit use for that area can then be applied to each component of the transportation cost determination to obtain the total annual household transportation expenditure. (FIG. 14) This transportation cost determination for total household transportation expenditure is then used as an input for the computer-implemented method of the present invention which calculates the combined housing and transportation costs of a specific area.

The independent variables are combined in a regression analysis that accounts for changes in the location variables that influence transportation costs, while controlling for the household characteristics that, to a lesser extent, also determine the costs. To develop the exact regression formula, each independent variable is tested separately against the dependent variables, and then in combination to determine their relationship. The analysis shows that the independent variables co-vary and are interdependent of one another. Thus, no one variable, such as transit accessibility or household income, by itself completely determines transportation costs. Rather, it is the combination of these variables that determines how many cars a household owns, how many miles household members drive each vehicle, and how much public transit they use.

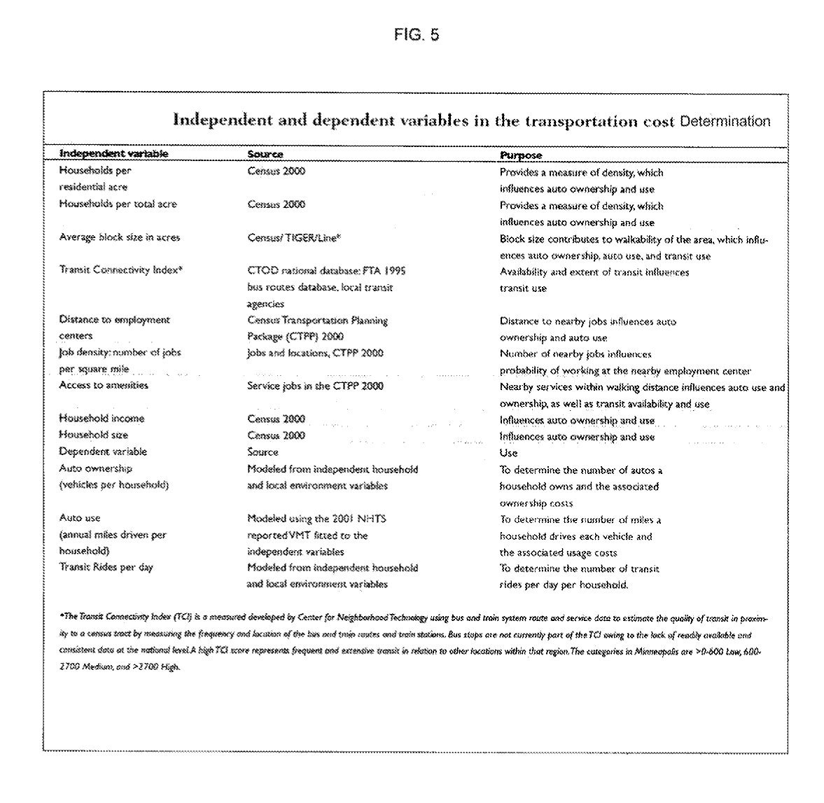

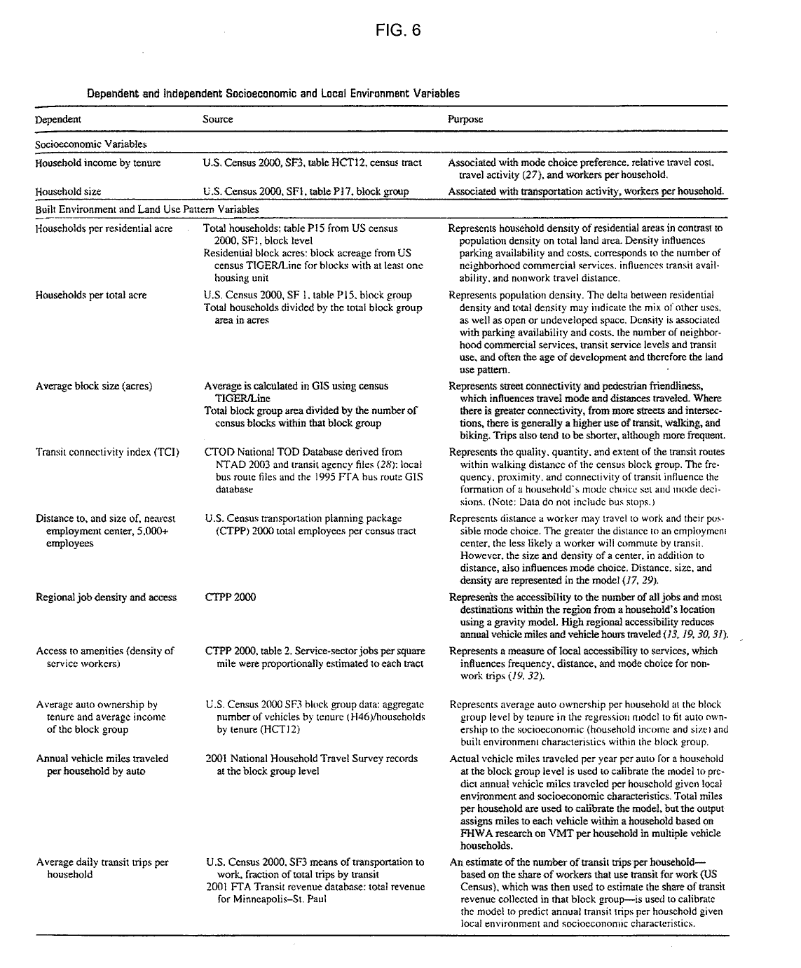

Values for thee independent variables are derived primarily from the 2009 American Community Survey 5-year Estimates, U.S. Decennial Census 2000 Survey; the Census Transportation Planning Package 2000 (CTPP 2000); the National Household Travel Survey (NHTS); and the National Transit-Oriented Development (TOD) database. The TOD database was developed by the CTOD with the support of the Federal Transit Administration, Fannie Made, and the Surdna Foundation. It contains the demographic, land use, and transportation characteristics of neighborhoods located within a half mile of 4,000 existing and planned fixed-guideway transit stations in the United States. The transportation characteristics in the database include the location of train stations and lines, train frequencies, bus routes, and actual and estimated bus route frequencies. Bus route information is collected from the Federal Transit Administration and from local transit authorities. The tables at FIGS. 5 and 6 provide a complete listing of these variables, their source, and describe their use in the transportation cost determination.

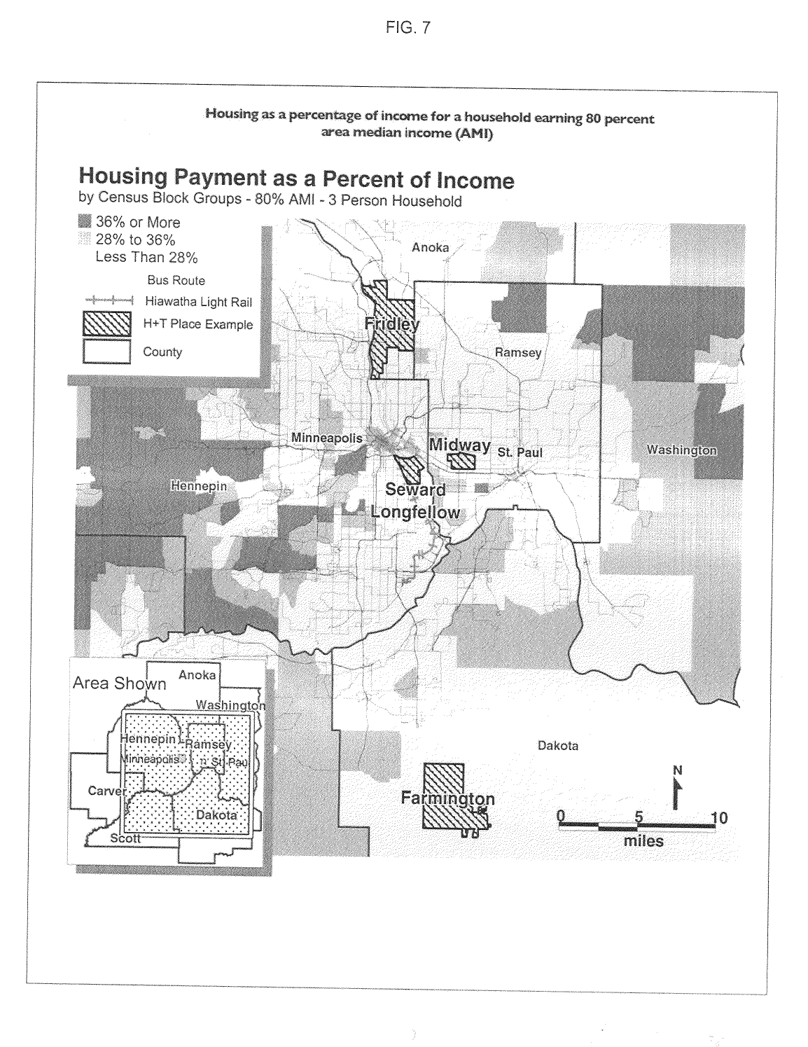

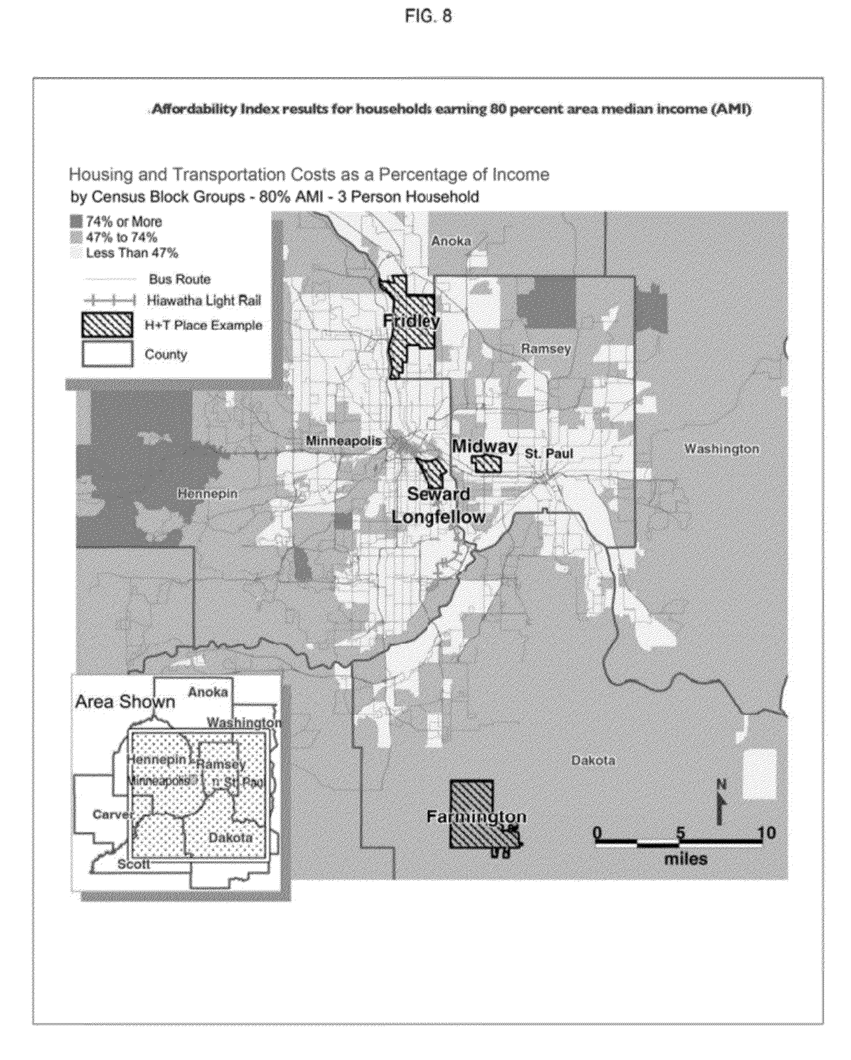

An embodiment of one aspect of the method of the present invention was initially tested in the Minneapolis-St. Paul region. The following affordability data shown for the Minneapolis-St. Paul area is an example of the application of the computer-implemented method of the present invention to actual data for a specific geographic region. The maps in FIGS. 7 and 8 illustrate the difference in affordability when considering only housing costs and when considering the combined cost of housing and transportation. Both maps depict the cost for households earning 80% of the area median income in the Minneapolis-St. Paul area. The map in FIG. 7 shows the monthly mortgage cost as a percentage of income. The lightest areas are those that would traditionally be deemed affordable; these areas are in accord with the lending guideline that requires households to spend 28% or less of their income on housing. The map in FIG. 8 adds transportation costs. In an embodiment, the method of the present invention uses a range for housing and transportation costs: less than 47% of income, 47-74%, and greater than 75%. The benchmark rate of 47% represents the sum of the current national average expenditure on transportation (estimated at 19% of income) plus the mortgage underwriting standard for housing debit of 28% or less of income. On the basis of a guideline that a household should spend no more than 47% of its income on housing and transportation, the areas considered affordable on a particular income contract substantially in FIG. 8 from those observed in FIG. 7.

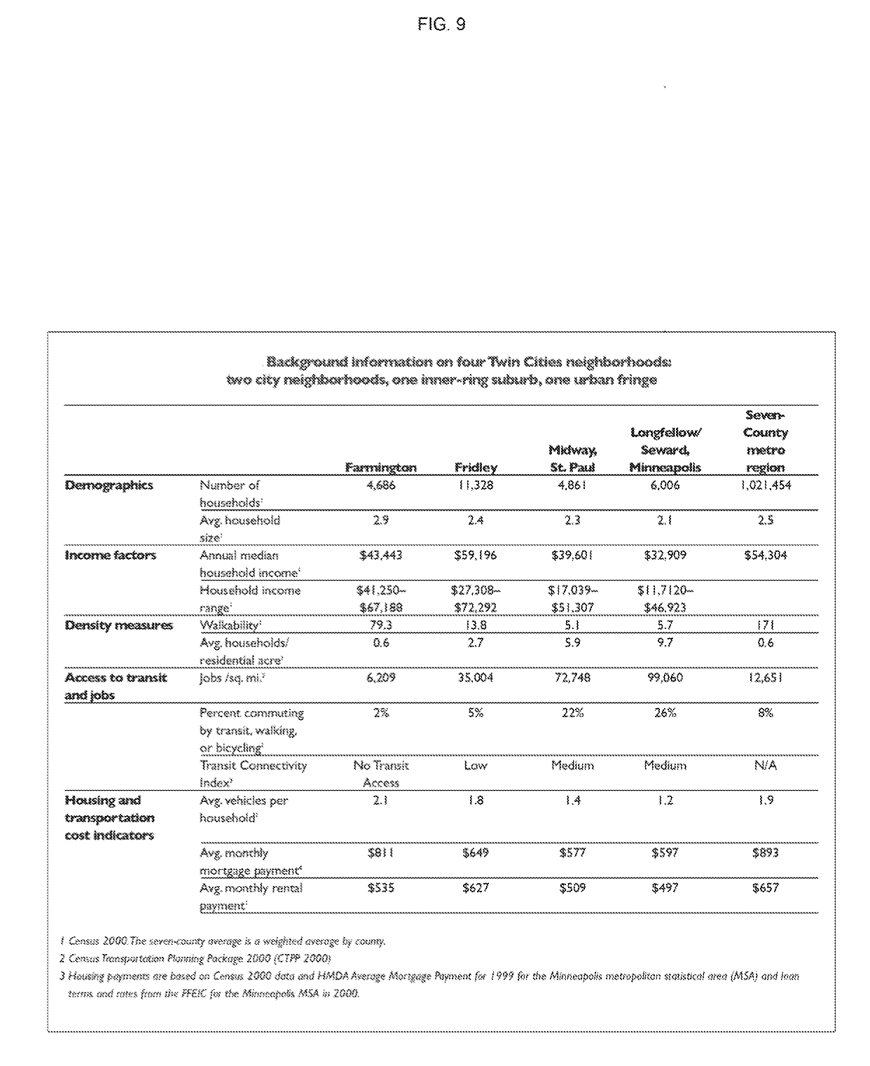

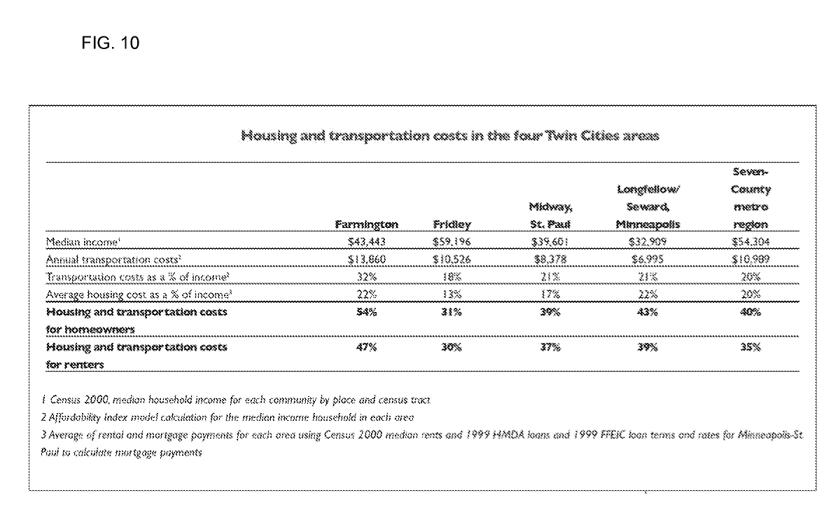

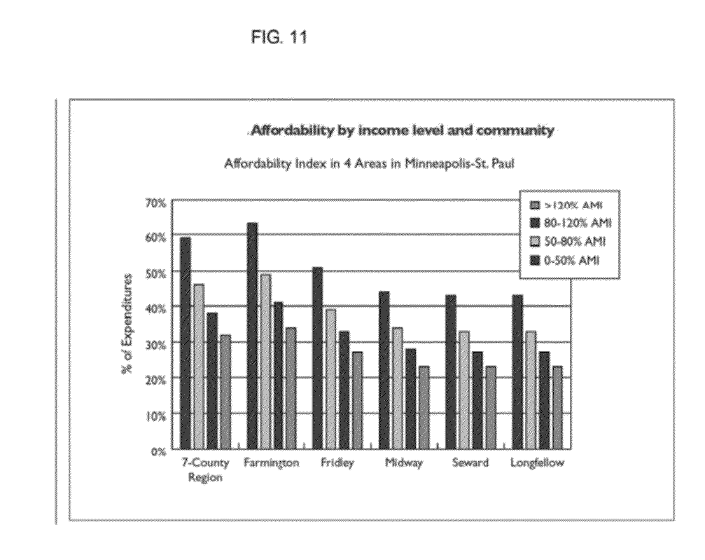

In one or more embodiments, the methods of the present invention further allow one to consider the effect on a typical family's budget of a variety of housing choices. The method of the present invention was tested in four neighborhoods of the Minneapolis-St. Paul area to confirm sensitivity of transportation costs to changes in density, housing costs, and proximity to public transit. The tables of FIGS. 9 and 10 provide more information regarding these neighborhoods. FIG. 9 provides additional demographic information for each neighborhood. FIG. 10 provides additional information regarding how that demographic information translates to the affordability of housing and transportation costs in that area. An embodiment of the method was also applied to households at various levels of the area median income (AMI). The graph at FIG. 11 shows the results of applying the method of the present invention to the same four neighborhoods at various income levels. Based on the results here, affordability varies greatly by location and across income levels. When transportation costs are added to housing costs, which are high throughout the metropolitan region, only the central city neighborhoods of Midway, Seward, and Longfellow are affordable to low-income families at less than 50% AMI. Affordability is indicated by a combined housing and transportation cost of less than 47% of household income. Proximity to better transit service in the central cities, access to more jobs, and the availability of some lower priced housing improves the overall cost of living for these households. For middle income families, reduced transportation costs in the same communities also has a positive effect on the family budget.

In an embodiment, each transportation cost component—auto ownership, auto use, and public transit—is a function of the local environment (Vₗₑ) of that place and household income and size (Vₕₕ) are specified. The overall equation is:

Total Transportation Cost=[Cₐₒ*F_{aO}(Vₗₑ)*Gₐₒ(Vₕₕ)]+[Cₐₒ*Fₐᵤ(Vₗₑ)*Gₐᵤ(Vₕₕ)]+[Cₐₒ*Fₚₜ(Vₗₑ)*Gₚₜ(Vₕₕ)] (Equation 1)

Where C represents a cost factor (i.e. dollars per mile driven), and F and G are generic functions of the local environment and the household variables. The subscripts “ao,” “au” and “pt” further refer to auto ownership, auto use, and percent transit journey to work, respectably.

By separating the urban variables and the household variables, the correlation of wealth and family size is removed from the characteristics of place assuring an assignment of the intrinsic value of the efficiency of any given place, without confusing the cost of transportation with the characteristics of households residing there.

The three base transportation cost components are each calibrated against existing measured data: average autos per household per block group (based on U.S. census data), vehicle miles traveled (VMT) (based on the National Household Travel Survey (NHTS), and the percent of journey to work trips by transit, and the share of FTA transit revenue database. Block groups are used as the base geography of analysis given that they are smaller in area than census tracts-yet detailed census data and other variables used in the analysis are still widely available.

The following items are key notes about transportation costs and how they are addressed in the methods of the present invention and the data sources. Federal Highway Administration (FHWA) research shows that VMT per vehicle varies as the number of autos per household increases. Therefore, the methods of the present invention make adjustments to assign the estimated miles per auto based on the NHTS results for multiple vehicles per household.

The methods of the present invention are able to estimate transportation costs for renters and owners separately, because households in each tenure represent a different cohort both in household size and income. The rental and ownership housing markets are different, which affects location choices.

In one example of an application of the methods of the present invention, the costs for auto ownership and use from FHWA estimates from the 2001 editions of the Complete Car Cost Guide and Complete Small Truck Guide from Intellichoice, Inc., and sales figures from Automotive News were used in making the estimates described herein. Auto ownership costs include depreciation, insurance, financing, and state fees. Auto use costs include fuel maintenance, fuel tax, and repairs. The FHWA estimates the fixed annual ownership and use costs by the type and age of vehicle. A weighted average for the two costs is used on the basis of the existing fleet of U.S. vehicles, which results in $5068 for the ownership component and 9 cents per mile for the use component. Because these costs are averages, in some cases, the method of the present invention will over or underestimate the ownership, use, or total costs. For instance, the ownership costs will be too high for vehicles that are older, smaller, or less expensive than the average vehicle on the road, and the auto use costs may be too low for these same vehicles, especially if they require more maintenance or are less fuel efficient. The pricing determination also does not account for variations in local economies or state regulations and how that might affect insurance rates, gasoline, and other auto costs.

Other than the CTOD national database, there is no single current and complete national source for all bus and rail lines in the United States. Several cities of the U.S. have no data or Geographic Information systems (GIS) files for their bus systems. For the Minneapolis-St. Paul area, for example, complete and current information on the bus routes and frequencies from the Met Council is included in the method, but the Transit Connectivity in the method does not include bus stop locations.

The methods of the present invention include data from the National Household Travel Survey (NHTS) to estimate the total vehicle miles driven per household on the basis of the census block group characteristics of the households in the survey. To account for access to jobs and services, which influence a household's transportation demand, a process is developed to identify employment centers both in size and location. Using the CTPP 2000, a number of jobs within each census tract is assigned. Those census tracts that are adjacent to each other and have a high employment density can be identified and grouped then as major employment centers. The distance from each block group to the closest employment center is then used as an independent variable in the method of the present invention.

The methods of the present invention use several data sources. The variables within the method are transformed from their original format to varying degrees. In particular, employment centers, transit connectivity index, and vehicle miles traveled require additional explanation beyond the information provided in the tables of FIGS. 5 and 6.

To identify the employment centers, a geographic information system (GIS) is used to identify clusters of jobs in contiguous census tracts that meet two thresholds: at least seven jobs per acre and at least 5,000 jobs. The centers are defined from a center point, and the outer boundaries are established when the adjacent tracts drop below the density threshold. Two measures of access to employment are used: the distance to the nearest large employment center from a household location, and the pull or attraction of all employment by census tract within the region, for example, the likelihood of where a household member will be employed. This second measure is calculated by the gravity determination, the sum of the ratio of the number of employees within all census tracts in the region over the distance to that tract squared. The two measures are weighted separately in the final regression equation.

The Transit Connectivity Index (TCI) represents the quality of fixed-route bus and rail transit services where available. Bus data in the Minneapolis/St. Paul area is used to calculate the frequency and extent of transit for a given block group. Quality of transit is based on access, intensity and frequency of transit service in a given census block group. Access is captured by a 0.25 ml buffer around each bus route. Intensity is based on the number of routes and trains that serve the census block group. Frequency is the sum of total weekly trips for all routes in both directions within the buffered area. This combined measure results in an index:

TCI=Σ[(0.25 mi buffer area intersecting block group)×(route total weekly trips)]/total census block group area

The National Household Travel Survey (NHTS) collects data on vehicle ownership and vehicle miles traveled (VMT) per automobile for individual households. The survey is reported at the county level, but the data set includes seven characteristics for the block group and surrounding tract, including percent of rental units, household and population density, county, and state. These seven characteristics were used to match the block groups in the survey with the census block groups for the entire United States. Of the 69,817 households in the NHTS sample, 8912 were unambiguously matches to a census block group, and 6840 household records had complete income and VMT data. Of these records, 92 were in the Minneapolis/St. Paul area, and the distribution of the sample in this region is similar to the national sample of 6840 records. VMT for each automobile in a household are summed to obtain a total VMT per household. This total VMT is then used as the variable in the regression analysis to predict household VMT.

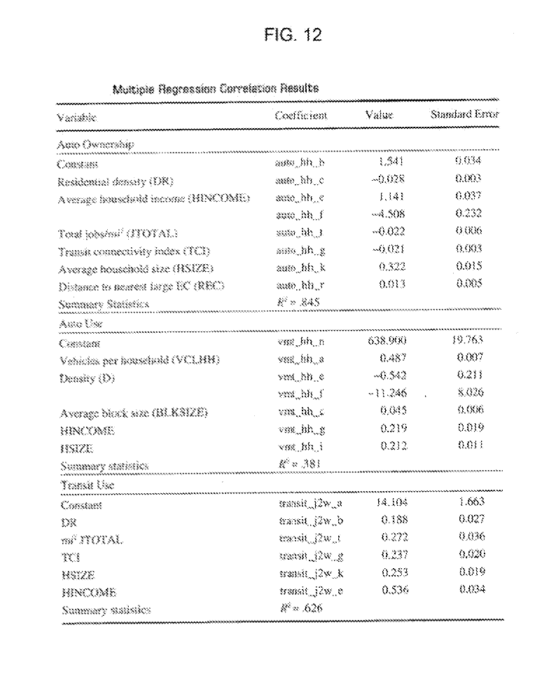

The three multiple regression equations for the transportation components are summed to derive total household costs for automobile ownership (AO), automobile use (AU), and transit (PT) as indicated in Equation 1 above. The predicted result from each component of the method is multiplied by the appropriate price for each unit—autos, miles, and transit trips—to obtain the cost of that aspect of transportation. For instance, the predicted autos per household are multiplied by the annual cost to own the average vehicle. The cost used may be adjusted by region, household income, or an average of the fleet of vehicles according to a source such as the Complete Car Cost Guide. FIG. 12 provides sample coefficients and standard error for the variables used in each of the three components and the R-squared values for each component for the method of the present invention.

### Automobile Ownership Component

For the automobile ownership component, the average household automobile ownership is 1.74 with a standard deviation of 0.42 according to the 2000 U.S. census data for the Minneapolis/St. Paul statistical area. The distribution follows a normal curve, so a standard multiple regression analysis is used:

Autos/hh=auto_{—}hh_{—}b*(DR^{auto}^{_{—}}^{hh}^{_{—}}^{c})*(1−exp(auto_{—}hh_{—}f*[HINCOME/100,000)^{auto}^{_{—}}^{hh}^{_{—}}^{e}]))*[(JTOTAL/10,000)auto_{—}hh_{—}t]*[exp(TCI*auto_{—}hh_{—}g/1,000)]*(HSIZE^{auto}^{_{—}}^{hh}^{_{—}}^{k})*(REC^{auto}^{_{—}}^{hh}^{_{—}}^{r})

where,
Autos/hh=Autos per Household
auto_hh_b=Autos per Household fit Coefficient—b
DR=Residential Density
auto_hh_c=Autos per Household fit Coefficient—c

auto_hh_f=Autos per Household fit Coefficient—f
HINCOME=Annual Household Income
auto_hh_e=Autos per Household fit Coefficient—e
JTOTAL=Total Jobs per Square Mile
auto_hh_t=Autos per Household fit Coefficient—t
TCI=Transit Connectivity Index (as defined herein above)
auto_hh_g=Autos per Household fit Coefficient—g
HSIZE=Household Size (People per Household)
auto_hh_k=Autos per Household fit Coefficient—k

### Automobile Use Component-VMT

The VMT per automobile from the NHTS is used as the dependent variable in regression equation with two local environmental variables, households per acre and average block size, socioeconomic variables, household income and size, and automobile ownership. Automobile ownership is added to this equation because independent variables tests clearly show that the miles driven per household are most dependent on number of automobiles per household. The regression analysis here is run by using the 6,840 block groups in the NHTS sample rather than the 2,007 block groups in the Minneapolis/St. Paul area.

VMT/hh=vmt_{—}hh_{—}n*exp(VCLHH^{vmt}^{_{—}}^{hh}^{_{—}}^{a})*(1−exp[vmt_{—}hh_{—}fp(D^{vmt}^{_{—}}^{hh}^{_{—}}^{e})])*BLKSIZE^{vmt}^{_{—}}^{hh}^{_{—}}^{c})*exp[(HINCOME/100,000)^{vmt}^{_{—}}^{hh}^{_{—}}^{g}]*exp(HSIZE^{vmt}^{_{—}}^{hh}^{_{—}}ⁱ)

where,
VMT/hh=Annual Vehicle Miles Traveled per Household
vmt_hh_n=Annual Vehicle Miles Traveled per Household fit Coefficient—n
VCLHH=Vehicles per Household
vmt_hh_a=Annual Vehicle Miles Traveled per Household fit Coefficient—a
vmt_hh_f=Annual Vehicle Miles Traveled per Household fit Coefficient—f
D=Gross Household Density
vmt_hh_e=Annual Vehicle Miles Traveled per Household fit Coefficient—e
BLKSIZE=Average Block Size (acres)
vmt_hh_c=Annual Vehicle Miles Traveled per Household fit Coefficient—c
HINCOME=Annual Household Income
vmt_hh_g=Annual Vehicle Miles Traveled per Household fit Coefficient—g
HSIZE=Household Size (People per Household)
vmt_hh_i=Annual Vehicle Miles Traveled per Household fit Coefficient—i

### Transit Use Component

The distribution for transit trips is binomial and peaks at zero. The best fit for this distribution comes from a simple regression rather than the more complex least squares fit. The following equation estimates the fraction of workers taking transit to work:

Transit mode share=(transit_{—}j2W_{—}a/10,000)*[(DR)^{transit}^{_{—}}^{jw}^{_{—}}^{b}]*([JTOTAL/10,000)]^{transit}^{_{—}}^{j2w}^{_{—}}^{t})*[(TCI)^{transit}^{_{—}}^{j2w}^{_{—}}^{g}]*(exp[(HSIZE*transit_{—}j2w_{—}k)])*(exp[1/(HINCOME/100,000)+transit_{—}j2w_{—}e])

where,
transit_j2W_a=Transit Mode Share fit Coefficient—a
DR=Residential Density
transit_jw_b=Transit Mode Share fit Coefficient—b
JTOTAL=Total Jobs per Square Mile
transit_j2w_t=Transit Mode Share fit Coefficient—t
TCI=Transit Connectivity Index (as defined herein above)
transit_j2w_g=Transit Mode Share fit Coefficient—g
HSIZE=Household Size (People per Household)
transit_j2w_k=Transit Mode Share fit Coefficient—k
HINCOME=Annual Household Income
transit_j2w_e=Transit Mode Share fit Coefficient—e

The predicted share of workers in a block group commuting by transit is then translated into transit use per household by using FTA transit database for 2001, which reports total transit trips for a household, the share of the population in a block group commuting by transit is applied to the total transit trips and then proportioned to the households:

Trips/household=α*transit mode share

Where α is total regional transit trips/Σ(transit mode share*households). This results in a distribution of transit trips per household with a mean of 2.4 daily one-way transit trips per household and a standard deviation of 2.88. This is a large standard deviation, and therefore this component does not as accurately predict transit trips as it does automobile ownership and VMT. However, for the significant share of households in the Minneapolis region that do not use transit, the transit costs are not overestimated. Annual predicted costs for transit in neighborhoods with high transit use were similar to what routine transit users report for annual transit expenditures in the Consumer Expenditure Survey.

A further embodiment of the inventions disclosed herein is constructed at the Census block group level. The H+T Index currently covers all Metropolitan and Micropolitan Areas in the Country, or the Core Based Statistical Areas (CBSAs) as defined by the Office of Management and Budget (OMB). Due to data limitations, CBSAs in Puerto Rico are currently excluded from the Index. The 2009 American Community Survey 5-year Estimates serve as the primary dataset, thereby dictating the use of the 940 CBSAs (excluding the 13 in Puerto Rico) as defined in 2008.

### Housing Costs

In the further embodiment referred to in the preceding paragraph housing costs are derived directly from nationally available datasets. Median Selected Monthly Owner Costs and Median Gross Rent, both from the 2009 American Community Survey 5-year Estimates (ACS), are averaged weighting by the ratio of owner to renter occupied housing units from the Tenure variable for every block group in the 940 CBSAs.

### Transportation Cost Model

While housing costs may be derived directly from ACS data, the transportation costs are modeled as three components of transportation behavior—auto ownership, auto use, and transit use—which are combined to estimate the cost of transportation.

The household transportation model is based on a multidimensional regression analysis, in which formulae describe the relationships between three dependent variables (auto ownership, auto use, and transit use) and independent household and local environment variables. Neighborhood level (Census block group) data on household income (both median and per capita), household size, commuters per household, household density (both residential and gross), street connectivity (as measured using average block size and intersection density), transit access, and employment access were utilized as the independent, or predictor variables.

To construct the regression equations, each predictor variable was tested separately; first to determine the distribution of the sample and second to test the strength of the relationship to the criterion variables. For this research, the regression analysis was conducted in a comprehensive way, thus ignoring the distinction between the local environment variables and the household variables in order to obtain the best fit possible from all of the independent variables. The predicted result from each model was multiplied by the appropriate price for each unit—autos, miles, and transit trips—to obtain the cost of that aspect of transportation. Total transportation costs were calculated as the sum of the three cost components as follows:

Household T Costs=[C_{AO}*F_{AO}(X)]+[C_{AU}*F_{AU}(X)]+[C_{TU}*F_{TU}(X)]

Where
C=cost factor (i.e. dollars per mile)
F=function of the independent variables (F_{AO} is auto ownership+F_{AU} is auto use and F_{TU} is transit use)

### Independent Variables: Neighborhood Characteristics

American Community Survey 5-year Estimates (ACS) for 2005-2009, at the block group level, serve as the primary data source for the independent variables.

### Household Density

Household density has been found to be one of the largest factors in explaining the variation in all three dependent variables. Various definitions of density have been constructed and tested, and the following two are utilized in the final transportation models.

### Residential Density

Residential Density represents household density of residential areas, in contrast to population density on land area. Total households are obtained at the block level from the 2010 US Census, and TIGER/Line files are used to define blocks. Blocks are selected on the criteria that gross density (households per land acre) must be greater than one. From these selected blocks, land acres are aggregated to calculate the total acres of residential blocks at the block group level. The count of households from the ACS is then divided by this land area to calculate the block group level residential density.

### Gross Density

Gross Density is calculated as total households (from the ACS) divided by total land acres (as calculated using TIGER/Line files).

### Street Connectivity and Walkability

Measures of street connectivity have been found to be good proxies for pedestrian friendliness and walkability. Greater connectivity, from more streets and intersections, creates smaller blocks, and tends to lead to more frequent walking and biking trips, as well as shorter average trips. While other factors clearly have an impact on the pedestrian environment (e.g., crime), two measures of street connectivity have been found to be important drivers of auto ownership, auto use, and transit use.

### Average Block Size

Census TIGER/Line files are used to calculate average block size (in acres) as the total block group land area divided by the number of blocks within the block group.

### Intersection Density

Again, Census TIGER/Line files are used, here to identify every street intersection. All streets in the TIGER/Line files are included (e.g., alleys, interstates, etc.). For each block group, the sum of all intersections (including those on the borders) is calculated and divided by the total land area of the block group.

### Transit Access

Transit access is measured through General Transit Feed Specification (GTFS) data.

### Transit Connectivity Index

The Transit Connectivity Index (TCI) is a measure of transit access developed specifically for use in this household transportation cost model.

To calculate this measure, a buffer was constructed around each transit access point (¼ mile radius for bus stops and ½ mile radius for rail stations and all other access points). Next, five concentric annuluses were constructed, each with the width of the initial buffer. These six access areas were then assigned a service frequency value (total trips per week) for the transit access point they surround.

Next, at the block group level, six access values were calculated. These were calculated (much like the TCI described on page 18) as:

land area of the access area intersecting the block group*service frequency value*weighting multiplier/total block group land area

The weighting multiplier identified in the above equation is calculated using regression analysis. Measured values of autos per household and percent journey to work by transit were each regressed against the six access values as defined above to obtain the optimal weighting multiplier for each. Therefore, two weighting multipliers are identified for each access area (one from the autos per household regression and one from the percent journey to work by transit regression). The rounded average of the two is used, and the six access values are summed for each block group in the final TCI calculation.

### Transit Access Shed

The Transit Access Shed is defined as the optimal accessible area from any block group within 30 minutes by public transportation scaled by the frequency of service. This measure was derived from the GTFS schedules. For each transit stop, all stops that can be reached within 30 minutes were identified. One transfer within 600 meters of a stop was allowed, and all transfers were padded with 10 minutes of walking and/or waiting. The stops reachable within 30 minutes were all based on the minimum travel time between the two stops, allowing the inclusion of more distant stops that are reachable within 30 minutes via express service. For each origination stop, a quarter mile buffer was created around the destination stops. Based on the location of the originating stop, the access shed was then aggregated for each stop to the block group and multiplied by the frequency of service (tips per week). Finally, the accessible area was derived and called the Transit Access Shed.

### Employment Access Index

Employment numbers are calculated using OnTheMap Version 5 which provides Local Employment Dynamics (LED) data at the Census block level. These data are currently unavailable in New Hampshire, Mass., and the District of Columbia. CNT created an alternative dataset for these areas using 2000 Census tract level data from the Census Transportation Planning Package (CTPP), scaled to 2007 using county level employment estimates from the Bureau of Labor Statistics (BLS). Utilizing a constant share method, the tract level variation from the 2000 CTPP data is preserved, while the 2007 county level BLS data enables updating to the appropriate time period. The estimates for New Hampshire, Mass., and the District of Columbia are then combined with the more compressive LED data available for all other states.

The Employment Access Index was determined using a gravity model, which considered both the quantity of and distance to all such destinations, relative to any given block group. Using an inverse-square law, an employment index was calculated by summing the total number of jobs divided by the square of the distance to those jobs. This quantity allows examination of both the existence of jobs and the accessibility of these jobs for a given census block group. Because a gravity model enables consideration of jobs both directly and not directly in a given block group, the employment access index gives a better measure of job opportunity, and thus a better understanding of job access than a simple employment density measure.

The employment access index is calculated as:

$$E ≡ {\sum }_{i = 1}^{n} \frac{{p}_{i}}{{r}_{i}^{2}}$$

Where E is the Employment Access for a given Census block group, n is the total number of Census blocks, pᵢ is the number of jobs in the ith Census block, and rᵢ is the distance (in miles) from the center of the given Census block group to the center or the ith Census block.

Because it was not feasible to include all jobs nationally in the calculation of employment access, jobs within 63 mile radius of a given block group were included. This cutoff was used as it represents the 90th percentile of commute distances nationally in the LED data.

### Independent Variables: Household Characteristics

American Community Survey 5-year Estimates (ACS), for 2005-2009, at the block group level, serve as the primary data source for the independent variables pertaining to household characteristics. These variables, median household income, per capita income, average household size, and average number of commuters per household, are described below.

### Median Income

Median household income is obtained directly from the ACS.

### Per Capita Income

Per capita income was calculated as median household income divided by average household size.

### Average Household Size

Average household size was calculated using Total Population in Occupied Housing Units by Tenure, and Tenure to define the universe of Occupied Housing Units.

### Average Commuters Per Household

Average commuters per household was calculated using the total workers 16 years and over who do not work at home from Means of Transportation to Work, and Tenure to define Occupied Housing Units. Because Means of Transportation to Work includes workers not living in occupied housing units (i.e. those living in group quarters), the ratio of Total Population in Occupied Housing Units to Total Population was used to scale the count of commuters to better represent those living in households.

### Dependent Variables

The dependent variables used in an embodiment of the model of the present invention, which are: auto ownership, auto use, and transit use, are described below.

### Auto Ownership

For the dependent variable of auto ownership, the regression analysis was fit using measured data on auto ownership obtained from the ACS. Aggregate Number of Vehicles Available by Tenure defined the total number of vehicles, and Tenure defined the universe of Occupied Housing Units. Average vehicles per occupied housing unit were calculated at the block group level.

### Auto Use

For the dependent variable of auto use, the regression analysis was fit using measured data representing the total amount that households drive their autos, or vehicle miles traveled (VMT) per automobile. In order to determine the amount that households drive their autos, odometer readings are utilized. Odometer readings for 2005 through 2007 were obtained from the Massachusetts Department of Transportation for the entire state at a 250 meter grid cell level. A similar dataset for the greater Chicago area was analyzed at the zip code level and compared with the Massachusetts dataset, resulting in similar findings. Due to the finer geographic scale of the Massachusetts dataset, the regression analysis is fit using these data.

### Transit Use

Because no direct measure of transit use was available at the block group level, a proxy was utilized for the measured data representing the dependent variable of transit use. From the ACS, Means of Transportation to Work was used to calculate a percent of commuters utilizing public transit.

### Regression Analysis

A rational function, a ratio of third order polynomials, was utilized as the functional form to regress each dependent variable:

$$R ( x ) ≡ \frac{{a}_{1} \times x + {a}_{3} \times {x}^{2} + {a}_{5} \times {x}^{3}}{1 + {a}_{2} \times x + {a}_{4} \times {x}^{2} + {a}_{6} \times {x}^{3}}$$

Because the GTFS data used to calculate independent variables of transit access, two regressions were fit and two models constructed for each dependent variable: one for regions with transit data and one for regions without.

Due to small samples sizes in the ACS, many block groups have missing data for various variables. The regressions were fit only where all independent and the given dependent variable were available. The models were ultimately run everywhere all independent variables were available.

For the vehicle miles traveled regressions, due to limitations in measured data, the analyses were only conducted for the state of Massachusetts. The resulting coefficients or models were then run for all regions in the country.

### Transportation Cost Calculation

As discussed, the transportation estimates three components of travel behavior: auto ownership, auto use, and transit use. To calculate total transportation costs, each of these modeled outputs is multiplied by a cost per unit (e.g., cost per mile) and then summed to provide average values for each block group.

### Auto Ownership Costs

The 2007 edition of the America Automobile Association's (AAA) Your Driving Costs report serves as the basis for the auto ownership cost component. AAA reports an average ownership cost per year composed of full-coverage insurance, license, registration and taxes, depreciation, and finance charges.

### Auto Use Costs

The 2007 Your Driving Costs report also serves as the basis for the auto use cost component. AAA reports an average operating cost per mile (composed of gas, maintenance, and tires). The gas component of AAA's operating costs is subtracted and replaced with regional fuel costs from the Energy Information Administration (EIA) to account for regional variation in gas prices.

### Transit Use Costs

The 2007 National Transit Database (NTD) served as the source for transit cost data. Specifically, directly operated and purchased transportation revenue were used (demand response revenue was not factored into this analysis). The transit revenue was assigned to each of the transit agencies where GTFS data had been collected. The allocation of transit revenue to the metropolitan level was then based on the percentage of each transit agencies' bus and rail stations within the primary versus surrounding metropolitan areas. For example, if a transit agency had a total of 500 bus stops and 425 of those stops were located in the primary metropolitan area and 75 stops extended into a neighboring metropolitan area, the primary metropolitan area received 85 percent of the transit revenue and the neighboring metropolitan area received 15 percent. The allocation of the transit revenue was then applied to the block group level based on the percentage of transit commutes and household commuter counts within each block group from the ACS, to estimate the average household transit costs.

There were a number of metropolitan areas for which GTFS data were not available and/or there was no revenue listed in the NTD. In these cases, the national transit cost average from the previous calculation was used for these metropolitan areas. The average transit costs were then allocated to the block group level based on the percentage of transit commutes and household commuter counts. The end result was an average household transit cost at the block group level.

### Constructing an Index

Because the model is constructed to estimate the three dependent variables (auto ownership, auto use, and transit use) as functions of independent variables, any set of independent variables can be altered to see how the outputs are affected. As a way to focus on the built environment, the independent household variables (income, household size, and commuters per household) were set at fixed values. This controls for any variation in the dependent variables that is a function of household characteristics, leaving the remaining variation a sole function of the built environment. In other words, by establishing and running the model for a “typical household,” (one defined as earning the regional area median income, having the regional average household size, and having the regional average number of commuters per household) any variation observed in transportation costs is due to place and location, not household characteristics.

### Model Findings

As discussed above, a rational function, a ratio of third order polynomials, was utilized as the functional form to regress each dependent variable:

$$R ( x ) ≡ \frac{{a}_{1} \times x + {a}_{3} \times {x}^{2} + {a}_{5} \times {x}^{3}}{1 + {a}_{2} \times x + {a}_{4} \times {x}^{2} + {a}_{6} \times {x}^{3}}$$

Each independent variable was normalized by a factor of ten to eliminate very large and small values, and Table 1 below shows the coefficients, normalization values, and resulting R-squared values from each of the six regression analyses.

TABLE 1
Regression Values

| | | | | | | Vehicle Miles | Vehicle Miles |
|---|---|---|---|---|---|---|---|
| | | | | Percent | Percent | Traveled | Traveled |
| | | Autos per | Autos per | Transit | Transit | Coefficient | Coefficient |
| | | Household | Household | Commutes | Commutes | Value (fit | Value (fit |
| | | Coefficient | Coefficient | Coefficient | Coefficient | including | without |
| | | Value (fit | Value (fit | Value (fit | Value (fit | transit data, | transit data, |
| | Coefficient | including | without | including | without | Massachusetts | Massachusetts |
| Variable | Number | transit data) | transit data) | transit data) | transit data) | only) | only) |
| R-Squared from Model Calibrations | | 75.13% | 74.06% | 60.73% | 59.30% | 83.54% | 81.87% |
| Intercept | | 0.9035021 | 0.8400562 | −12.67211 | −39.0621 | 27718.69 | 25287.76 |
| Residential Density | 1 | −2.334157 | −2.128126 | −2.022163 | −1.21996 | −386.0753 | −45.03022 |
| Residential Density | 2 | 0 | 0 | −2.697689 | −2.840986 | 0 | 0 |
| Residential Density | 3 | 2.894528 | 2.386935 | 3.967755 | 1.990148 | 0 | 0 |
| Residential Density | 4 | 99.51484 | 82.54479 | 3.136924 | 2.650528 | 0.008457189 | 0.000120798 |
| Residential Density | 5 | 0 | 0 | −0.3633148 | −0.05469808 | 0 | 0 |
| Residential Density | 6 | 0 | 0 | 0 | 0 | 0 | 0 |
| Residential Density | normalization | 100 | 100 | 10 | 10 | 1 | 0.1 |
| | factor | | | | | | |
| Gross Density | 1 | −28.7484 | −2.632833 | 81.61322 | −2.073266 | −645.0128 | −452.4996 |
| Gross Density | 2 | 62.27996 | 5.703493 | 16.43917 | 0 | 0.1869187 | 0.1277382 |
| Gross Density | 3 | 0 | 0.01900487 | −129.3881 | 8.484414 | −0.9011985 | −0.6557179 |
| Gross Density | 4 | 6.936574 | 0.1207291 | 0 | 0.1952978 | 0 | 0 |
| Gross Density | 5 | −21.21335 | −0.03207406 | 148.1034 | 0 | 0 | 0 |
| Gross Density | 6 | 16.95913 | 0.02319127 | 3.863221 | 0 | 0 | 0 |
| Gross Density | normalization | 10 | 1 | 10 | 10 | 0.1 | 0.1 |
| | factor | | | | | | |
| Average Block Size | 1 | 0 | 0 | 0.02481908 | −33.34488 | −3.356055 | −11.57821 |
| Average Block Size | 2 | −2.637627 | −22.67568 | 0 | 5.418418 | 0 | 0 |
| Average Block Size | 3 | 0.06042393 | 6.396586 | 0 | 0 | 0 | 0.02023189 |
| Average Block Size | 4 | 2.613908 | 208.1047 | 0 | −0.05940717 | 0 | 0 |
| Average Block Size | 5 | 0 | 0.42072 | 0 | 0.006506276 | 0 | 0 |
| Average Block Size | 6 | 0 | 0 | 0 | 0 | 0 | 0 |
| Average Block Size | normalization | 10 | 100 | 10 | 10 | 1 | 1 |
| | factor | | | | | | |
| Intersection Density | 1 | −0.03924194 | 0.1562041 | −7.039866 | −8.783131 | −5229.999 | −5873.48 |
| Intersection Density | 2 | −60.49794 | −48.91733 | −2.490525 | −1.985139 | 0.6032584 | 0.5304007 |
| Intersection Density | 3 | 0 | 0 | 17.0348 | 21.00875 | 0 | 0 |
| Intersection Density | 4 | 993.6968 | 657.99 | 2.536276 | 1.705947 | 0.01059301 | 0.01410769 |
| Intersection Density | 5 | 134.2386 | −12.43564 | −9.696218 | −10.52933 | 0 | 0 |
| Intersection Density | 6 | 0 | 0 | −0.2347699 | −0.1661309 | 0 | 0 |
| Intersection Density | normalization | 10 | 10 | 1 | 1 | 0.1 | 0.1 |
| | factor | | | | | | |
| Transit Connectivity | 1 | −0.5457389 | 0 | 2.196592 | 0 | −5960.294 | 0 |
| Index | | | | | | | |
| Transit Connectivity | 2 | 0.252349 | 0 | −33.20861 | 0 | 1.890105 | 0 |
| Index | | | | | | | |
| Transit Connectivity | 3 | 0.1584514 | 0 | −72.83083 | 0 | −21.66471 | 0 |
| Index | | | | | | | |
| Transit Connectivity | 4 | 0 | 0 | 1.214745 | 0 | −0.001921236 | 0 |
| Index | | | | | | | |
| Transit Connectivity | 5 | −0.01352281 | 0 | 0 | 0 | 0.04369136 | 0 |
| Index | | | | | | | |
| Transit Connectivity | 6 | 0 | 0 | −0.1139524 | 0 | 0 | 0 |
| Index | | | | | | | |
| Transit Connectivity | normalization | 100000 | 0 | 10000 | 0 | 1000 | 0 |
| Index | factor | | | | | | |
| Transit Access Shed | 1 | −3.855986 | 0 | 3.439286 | 0 | −43.39204 | 0 |
| Transit Access Shed | 2 | 0 | 0 | 0 | 0 | 0 | 0 |
| Transit Access Shed | 3 | 0 | 0 | −2.275199 | 0 | 0 | 0 |
| Transit Access Shed | 4 | 0 | 0 | 1.014861 | 0 | 0.001060714 | 0 |
| Transit Access Shed | 5 | 0 | 0 | 0 | 0 | 0 | 0 |
| Transit Access Shed | 6 | 2762307 | 0 | 0 | 0 | 0 | 0 |
| Transit Access Shed | normalization | 1E+12 | 0 | 1E+11 | 0 | 10000000000 | 0 |
| | factor | | | | | | |

TABLE 2
Regression Values (continued)

| | | | | | | Vehicle Miles | Vehicle Miles |
|---|---|---|---|---|---|---|---|
| | | | | Percent | Percent | Traveled | Traveled |
| | | Autos per | Autos per | Transit | Transit | Coefficient | Coefficient |
| | | Household | Household | Commutes | Commutes | Value (fit | Value (fit |
| | | Coefficient | Coefficient | Coefficient | Coefficient | including | without |
| | | Value (fit | Value (fit | Value (fit | Value (fit | transit data, | transit data, |
| | Coefficient | including | without | including | without | Massachusetts | Massachusetts |
| Variable | Number | transit data) | transit data) | transit data) | transit data) | only) | only) |
| Employment Access | 1 | −2.290767 | −4.979824 | 2.808401 | 10.69304 | −266.1583 | −2149.144 |
| Index | | | | | | | |
| Employment Access | 2 | 3.018469 | 5.331404 | 0 | −0.315026 | 0 | 0 |
| Index | | | | | | | |
| Employment Access | 3 | 0 | 0 | 0 | 2.85298 | 0 | 0 |
| Index | | | | | | | |
| Employment Access | 4 | 0 | 0 | −0.2658001 | 0.2345715 | −0.06962806 | −0.02985197 |
| Index | | | | | | | |
| Employment Access | 5 | 0 | 0 | 1.482218 | 0 | 21.07029 | 173.9755 |
| Index | | | | | | | |
| Employment Access | 6 | 0 | 0 | 0.2413463 | 0 | −0.004067758 | −0.01453318 |
| Index | | | | | | | |
| Employment Access | normalization | 1000000 | 1000000 | 100000 | 100000 | 1000 | 10000 |
| Index | factor | | | | | | |
| Median Income | 1 | 0 | 0 | 0 | 0 | −37.50369 | 235.349 |
| Median Income | 2 | 0 | 0 | 0 | 0 | 0 | 0 |
| Median Income | 3 | 2.267462 | 2.282422 | 973.8564 | 902.6597 | 1.012698 | −7.372369 |
| Median Income | 4 | 1.88447 | 1.873491 | 0 | −4.439021 | 0 | 0 |
| Median Income | 5 | 0 | 0 | −3907.073 | −3620.513 | 0 | 0.09321393 |
| Median Income | 6 | 0 | 0 | −64.73575 | −46.79217 | 2.96868E−7 | 4.12277E−06 |
| Median Income | normalization | 100000 | 100000 | 1000000 | 1000000 | 1000 | 1000 |
| | factor | | | | | | |
| Per Capita Income | 1 | 2.901765 | 3.658799 | −7.769942 | −61.40629 | 0 | 0 |
| Per Capita Income | 2 | −3.029542 | −2.259577 | 0 | 2.829612 | −0.4828993 | −0.4766037 |
| Per Capita Income | 3 | −4.919472 | −4.752395 | 1.060646 | 3.149947 | 165.3224 | 219.2716 |
| Per Capita Income | 4 | 23.25156 | 26.0626 | 0.2211125 | 0 | 0.07884006 | 0.0825098 |
| Per Capita Income | 5 | 0 | 0 | −0.6513893 | −1.723118 | −45.78913 | −61.60924 |
| Per Capita Income | 6 | 0 | 0 | 0 | 0.02783777 | 0 | 0 |
| Per Capita Income | normalization | 100000 | 100000 | 10000 | 10000 | 10000 | 10000 |
| | factor | | | | | | |
| Average Household | 1 | 1.209951 | 1.081246 | 1.832001 | 21.78629 | −7.593727 | −8.384842 |
| Size | | | | | | | |
| Average Household | 2 | −5.847602 | −4.888731 | 0 | 0.2341225 | 0 | 0 |
| Size | | | | | | | |
| Average Household | 3 | −7.075359 | −5.372761 | 0.0345855 | −0.3132465 | 0.02227081 | 0.0211328 |
| Size | | | | | | | |
| Average Household | 4 | 8.81938 | 6.27477 | 0.002724238 | −0.002605517 | 0 | 0 |
| Size | | | | | | | |
| Average Household | 5 | 10.63805 | 6.985885 | 0 | 0.00088434 | 0 | 0 |
| Size | | | | | | | |
| Average Household | 6 | 0 | 0 | 0 | 0 | 0 | 0 |
| Size | | | | | | | |
| Average Household | normalization | 10 | 10 | 0.1 | 0.1 | 0.01 | 0.01 |
| Size | factor | | | | | | |
| Average Commuters | 1 | 4.094289 | 4.578163 | −8.013672 | −11.45129 | 52.7161 | 54.39543 |
| per Household | | | | | | | |
| Average Commuters | 2 | 0 | 0 | 0 | 0.2317086 | 0 | 0 |
| per Household | | | | | | | |
| Average Commuters | 3 | −5.094867 | −6.754153 | 0 | 2.928683 | −0.1697261 | −0.1739262 |
| per Household | | | | | | | |
| Average Commuters | 4 | 0 | 0 | 0.4257387 | 0 | 0 | 0 |
| per Household | | | | | | | |
| Average Commuters | 5 | −10.70363 | −9.412954 | 0 | 0 | 0 | 0 |
| per Household | | | | | | | |
| Average Commuters | 6 | 0 | 0 | 0 | 0 | 0 | 0 |
| per Household | | | | | | | |
| Average Commuters | normalization | 10 | 10 | 1 | 1 | 0.01 | 0.01 |
| per Household | factor | | | | | | |

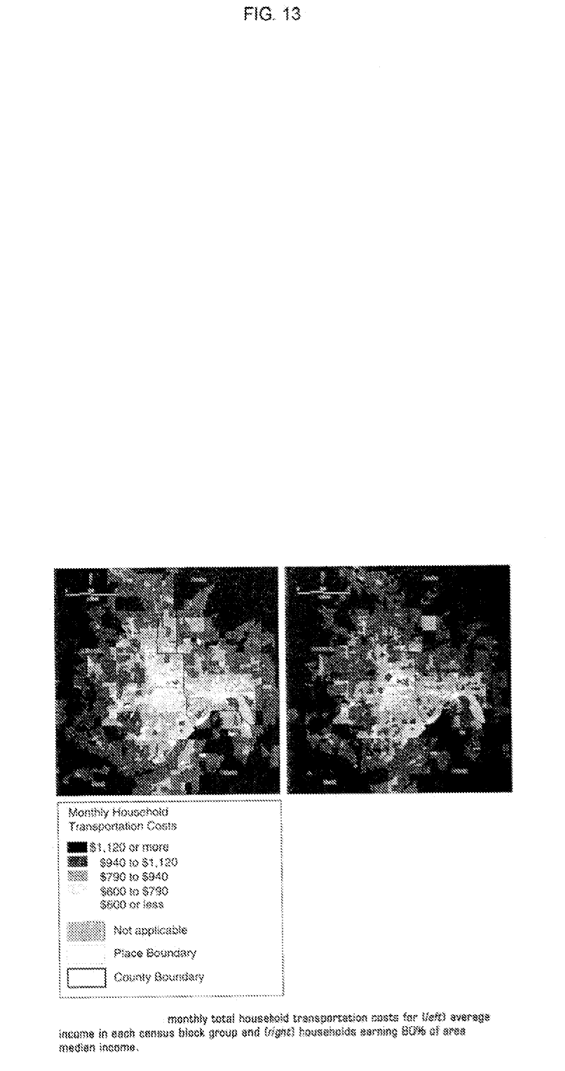

To obtain the estimates of household transportation costs for a given block group, the method of the present invention can use any combination of income or household size. To estimate the affordability to households in their current location, the method uses the existing average income and size in each block group as the socioeconomic inputs. To determine where a household of a given income could afford to live, given each neighborhood's associated transportation costs, the method uses a single income, for example, 80% of area median income. FIG. 13 shows the specific output transportation costs for four neighborhoods plus the seven county average for the Minneapolis/St. Paul area for three different income levels and household sizes. The four neighborhoods represent an exurban community, Farmington; an older middle ring suburb, Fridley; and two city neighborhoods, Midway in St. Paul, and Seward in Minneapolis. Applying the method to the same three sample households across four neighborhoods shows how both the built environment and household characteristics affect transportation demand and the associated costs. The neighborhood characteristics in Midway and Seward include smaller block sizes, making them more walkable; a greater number of services within the neighborhood, making nonwork trips accessible by multiple modes and at shorter distances; greater residential densities, which supports more local services and job opportunities; higher levels of transit connectivity, making transit more attractive and usable; and closer proximity to large centers of employment, making the commute trip shorter and more likely doable by transit. In Farmington, the block sizes are more than 40 acres, making them unwalkable for short trips, and the job density is very low so there are few nonresidential uses or jobs available in most neighborhoods. The nearest employment center is more than 10 miles away, and the transit connectivity is close to zero. These neighborhood differences explain why the method of the present invention predicts a three-person household earning $54,304 a year will own 2.19 vehicles and take no transit in Farmington but own 1.09 and 1.43 vehicles in Seward and Midway respectively and take from 18 to 156 transit trips per year.

As a composite index of the quality of the built environment, the transportation cost determination for the method of the present invention provides an estimate, controlling for a household's size and income, of how the built environment will influence a household's transportation demand in a particular neighborhood. The combination of these factors explains approximately two-thirds of the variation in household travel activity. The other third may be a factor of household preferences and other characteristics, such as the number and age of children, or additional factors of the built environment such as crime, weather, pedestrian environment, and school quality. Hence, both the demand for transportation (socioeconomic) and the supply of destinations and transportation (built environment) influence automobile ownership, automobile use, and transit use.

Once the method of the present invention has been calibrated as described in detail here, the coefficients of the non-linear regression (FIG. 12) are placed in a database table 10. In some embodiments, different types of cities may require different methods of the present invention. The database 10 will have, for every sub-geography, all of the relevant geographic variables for the method. As set forth in FIGS. 5 and 6 these variables may include households per acre, average block size, the distance to employment centers, job density, average household income, and average household size for example. After the database 10 is created, a database function is programmed using a structured query language (SQL) to apply the method of the present invention. The database function uses the coefficients in the database tables.

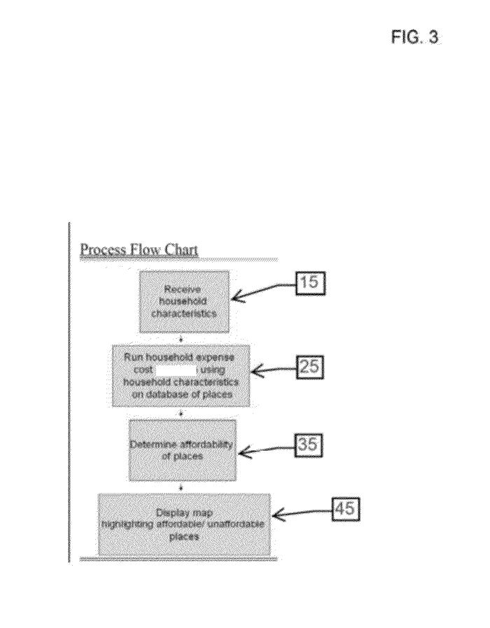

An embodiment of the system of the present invention requires a web interface 30 (See FIG. 2). In an embodiment the web interface may be written in PHP hypertext programming language. The web interface allows the user to input personal, customized household variables for his or her actual household circumstances 15 and to select a specific geography for the analysis. (FIG. 3). Using the server 50, the system of the present invention takes the user supplied inputs 15 (FIG. 3), runs the cost determination 25 on all the sub-geographic areas in the selected geographic regions to quantify the transportation cost for each block group. In an embodiment, the system of the present invention uses a PHP/SQL function.

The system of the present invention, reading the web page with the household inputs, calls an application programming interface (API). The API runs an SQL query. Included in the SQL query is a call to the SQL function. The SQL function uses the calibrated results of the regression analysis for the selected region, to create a temporary geographic information system (GIS) database table which lists, for the given household variables, the dependent variables (transportation cost components) of the transportation cost determination for each subgeography in the selected region. As indicated in FIGS. 5 and 6, these dependent variables include auto ownership per household, automobile use in household, and transit use per day. This table can be displayed to the user either as a list or as a map. The database table can be displayed as a map using code written in PHP, JavaScript, Ajax, for example and without limitation, and using a web-based map server such as Google Maps, Map Server, and Open Layers, for example.

The system of the present invention sets an initial affordability criteria of 15% of income for transportation costs. Using the user's income entered on the web interface 30, the system of the present invention calculates 15% of the income. The system, through a SQL query updates the table to mark those sub-geographies that have transportation costs below the 15% of the user's income and those that have transportation costs above 15%. These block-groups or subgeographies can then be displayed as a map with the affordable areas highlighted in a color or other indicia distinct from the unaffordable regions 45. The user can then also select new criteria for affordability here such as 10 or 20% of income and the method of the present invention will recalculate those affordable and unaffordable areas.

For every sub-geography or block group, the system of the present invention calculates suggested affordable monthly ownership costs. The initial suggested affordable level for combined housing and transportation costs is 45% of income. The system will calculate 45% of the user-supplied household income on the web interface 30 and subtract the transportation cost as determined for that region. The difference here is the suggested affordable housing cost. The table is again updated to include this suggested affordable housing cost for each sub-geography in the region. This information can be displayed to the user for each sub-geography either as a list or again as part of a geographical map. The user can also select new criteria for affordability such as 30% or 50% of income.

Using a database of average housing costs for each sub-geography and an SQL function, the original table can be updated to flag each sub-geography where the average housing cost is less than or equal to the suggested affordability cost. Using an SQL function, this sub-geography is then marked as “affordable” in the present invention on the display map. Where the housing cost is higher than suggested, the sub-geographies are marked as “unaffordable” on the display map. This information can again be displayed as a list or as a map as indicated. The affordable areas are highlighted and distinguished from the unaffordable regions either by color or other similar indicia. For example, if a user has an annual household income of $100,000, the system of the present invention will identify all sub-geographies in the region where the combined housing and transportation costs are $45,000 or less.

Referring again to FIG. 1, after the system of the present invention determines the suggested affordable housing cost for each sub-geography and by using a data-feed of housing costs from a real estate database 34, the system will then identify all available properties 44 in every sub-geography that are above or below the affordability criteria. The available properties can also be displayed as a list or on a map 45. The system of the present invention can identify either properties for sale or properties available for rent. The user may again change the affordability criteria threshold from 45% on the web interface and the processor will recalculate affordable available properties. For example, the affordability criteria could be changed to 30% or 50%. In an embodiment, if a user has an annual household income of $100,000, the processor will identify, for all sub-geographies in the selected region, all houses where the annual housing cost plus the cost of transportation, for the user's household in that sub-geography, equals 45% or less of the user's income.

Referring to the figures, the following is a description of an illustrated method for using the present invention. Referring specifically to FIG. 4, the software interface may provide a prospective user with an option to login or sign up to use an embodiment of the system of the present invention at 77. Upon selection of either option, the user is presented with a login page that prompts the user to enter a user name and password or other security code. If it is the first time the user is accessing the system, the user may have the option to select a user name and password and become an authorized user of the system. An authorization process subsequently accesses a user database which contains the names and passwords of all authorized users. The authorization process compares the user name and password entered by the prospective user against the user database. In an embodiment, there is no direct access to the geographic database or to the database of the calculated transportation costs by the user. If the authorization process cannot match the user name and password entered by the user to any authorized user in the user database, the prospective user cannot proceed past the login page. If the user name and password entered by the prospective user matches an authorized user in the User Database, the authorization process recognizes the prospective user as an authorized user and allows the authorized user to proceed to the input screen. (FIG. 4) In an embodiment of the system of the present invention, this login function may be optional. A user may be able to access the system, but would not be able to save their household inputs, personal information, or search results without logging in as an authorized user.

At the user interface screen 30 shown at FIG. 4, a user may enter certain household characteristics such as annual income 55, a home address 65, if appropriate, the number of workers in his or her household 75, and each worker's office address 76. A user may also select modes of transportation 80 used in the household. After the user enters the parameters and prompts the system to begin the search at 81, the system of the present invention will then display the monthly housing and transportation budget 85 for the user as a percentage of monthly income 95 based on the region selected. The system of the present invention will then display the affordable areas of the region selected for the analysis distinguished from the unaffordable areas at 86. The user can also change the percentage of monthly income 95 to a selected affordability criteria threshold and rerun the analysis by selecting “Update” 96. The system of the present invention also provides available real estate listings and/or rental properties which would fall within a user's affordable and/or unaffordable areas. The properties are listed on the user interface 30 at 97 and are superimposed on a graphical display of affordability as indicated at 98. In an embodiment, a user may also select specific neighborhoods 86 for comparison of housing and transportation costs. The system of the present invention will then calculate the housing and transportation costs for those neighborhoods. Based on the user's housing and transportation budget 85 for the household's monthly income, the system of the present invention will calculate which of those neighborhoods are affordable 87 for the user and which are not affordable 88. The system of the present invention can also provide information to the user regarding ways to reduce costs and expand affordable neighborhoods at 89.

In alternate embodiments of the present invention, additional household expenses such as, for example and without limitation, electricity, natural gas, health care costs, and food costs could also be determined and the respective affordability calculated in various geographical regions.

A user could request further refinement of the zone of affordability by altering household characteristics such as number of cars or the preferred transportation method. The user could enter less or more information to run the method and obtain the same analysis of the affordability zone, albeit less customized. In still another alternate embodiment, a user may be able to alter certain inputs such as gas prices, for examples.

In various embodiments, the zone of affordability displayed could comprise census blocks, census block-groups, census TRACTS, municipalities, political boundaries, school districts, neighborhoods, counties, zip codes, or the like.

Similarly, the selected geographic region could comprise a neighborhood, a municipality, a state, a county, a political boundary, a country, or the like.

In an alternate embodiment, the housing and transportation costs could also be drawn from sources of measured data without additional cost determination.

It will be appreciated by persons skilled in the art that the present invention is not limited by what has been particularly shown and described herein. Rather, the scope of the present invention is defined only by the claims which follow.

We claim:

1. A geographical information system for displaying affordability data of areas in a selected geographic region wherein affordability is a defined threshold criteria of combined household and transportation costs as a percentage of income for a specific geographic area, the geographical information system comprising:
a computer, the computer including a processor, memory, a communication link, and a display device;
a table of transportation costs calculated by using geographic variables, household variables, and user inputted variables;
a database of geographic variables;
a user interface that allows a user to select a geographic region to search, select a value for each of the household variables, and select the affordability criteria threshold;
a link to a real estate database which provides data on housing costs to the geographical information system to identify properties in at least one area of the selected geographic region with costs that are above or below the affordability criteria threshold;
wherein the affordability data can be displayed as a table or as a geographical map for the user; and
wherein the areas with average housing costs below the affordability criteria threshold are marked as affordable by a first indicia on the display and the areas with average housing costs above the affordability criteria threshold are marked as unaffordable with a second indicia on the display.

2. A computer-implemented method of displaying affordability data for areas in a selected geographic region wherein affordability is a defined threshold criteria of combined household and transportation costs as a percentage of income for a specific geographic area, the method comprising:
building a database of geographic variables;
building a table of transportation costs using geographic variables, household variables, and user inputted variables;
selecting a geographic region to search, selecting a value for each of the household variables, and selecting the affordability criteria threshold through a user interface;
calculating transportation costs for a household based on user-inputted variables;
providing information from a real estate database to identify properties in at least one area of the selected geographic region with costs that are above or below the threshold affordability criteria;
displaying through a display device the areas with average housing costs below the threshold affordability criteria marked as affordable by a first indicia on the display and the areas with average housing costs above the threshold affordability criteria marked as unaffordable with a second indicia on the display; and
wherein the display may be a table or a geographical map for the user.
